(19) United States
(12) Patent Application Publication
(10) Pub. No.: US 2022/0389700 A1
(43) Pub. Date: Dec. 8, 2022

(54) INSTALLATION TOOL AND METHOD FOR A TOILET

(71) Applicant: AS AMERICA, INC., Piscataway, NJ (US)

(72) Inventors: Beda Angelo Pormentilla, Jersey City, NJ (US); Robert M. Jensen, East Brunswick, NJ (US); Ali Ekbatani, Irvine, CA (US); Antonio Esposito, Colonia, NJ (US)

(73) Assignee: AS AMERICA, INC., Piscataway, NJ (US)

(21) Appl. No.: 17/775,491

(22) PCT Filed: Nov. 13, 2020
(86) PCT No.: PCT/US2020/060359

§ 371 Date: May 9, 2022

Related U.S. Application Data
(60) Provisional application No. 62/935,334, filed on Nov. 14, 2019.

(51) Int. Cl. E03D 11/16; F16B 37/14; F16B 23/00

(52) U.S. Cl. CPC E03D 11/16; F16B 37/145; F16B 23/0007

(57) ABSTRACT

An installation tool assembly kit for a toilet, comprising an installation wrench and an installation nut, wherein the wrench is configured to be removably coupled to the nut via an upper aperture of the nut, the nut is configured to be threadingly coupled to a flange bolt via a lower aperture of the nut, and the nut upper aperture and nut lower aperture are concentrically aligned. The toilet may be a concealed trap, skirted toilet and/or a pressure-assist toilet.

The disclosure relates to an installation tool assembly or kit for installation of a toilet; and to a method of installing a toilet.

### BACKGROUND

Installation of a toilet assembly typically includes positioning mounting bolts through slots in a closet flange that is designed to be aligned and spaced with respect to a wall behind the toilet to be installed. The bolts fit into slots in the flange so that the head of the bolt is positioned on the floor and the bolt stem stands upright. The bowl portion of a two-piece toilet, or an entire one-piece toilet, is lowered so that the flange bolts are inserted through receiving holes in the base of the toilet. The toilet is typically prepared with a wax seal prior to being seated on the floor. The toilet is then affixed to the flange bolts with an assembly including a gasket, a washer, and a nut. The bolts are then typically cut to size with a bolt cutter and/or hack saw and a cap is placed over the remaining portion of the bolt.

Concealed trapway, or “skirted” toilets, generally have a smooth, clean surface from front to back, the trapway being hidden in an interior cavity of the toilet. Such toilets are installed by placing on flange mounting bolts as are conventional toilets. In order to gain access to the mounting bolts, access holes are present on either side of the toilet base. The toilet is then affixed to the flange bolts with a nut through the access holes. The access holes are then covered with a cap.

Desired are toilets having a more smooth, clean surface from front to back, having no access holes and caps. Also desired are small footprint, low profile toilets having a pressure-assisted flush. Pressure-assisted toilets include an apparatus or assembly comprising one or more pressure tanks positioned in an interior thereof. The apparatus may not allow for much space and may prohibit access to flange bolts for installation.

A tool assembly for installing a concealed trapway toilet and/or a pressure-assist toilet is highly desired.

### SUMMARY

Accordingly, disclosed is an installation tool assembly kit for a toilet, comprising an installation wrench and an installation nut, wherein the wrench is configured to be removably coupled to the nut via an upper aperture of the nut, the nut is configured to be threadingly coupled to a flange bolt via a lower aperture of the nut, and the nut upper aperture and nut lower aperture are concentrically aligned.

Also disclosed is a method for installing a toilet, comprising inserting a wrench lower end into a nut upper aperture to form an installation tool assembly, lowering the installation assembly so that a nut lower aperture threadingly engages a flange bolt, turning the installation wrench to threadingly tighten the installation nut onto the flange bolt, and pulling and removing the installation wrench from the installed nut. In some embodiments, an installation wrench may be inserted through a toilet seat post hole, and the installation nut may be coupled to the wrench from under the seat post hole.

### BRIEF DESCRIPTION OF THE DRAWINGS

The disclosure described herein is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1 shows an installation wrench, according to an embodiment.

FIG. 2A and FIG. 2B show an installation nut, according to an embodiment.

FIG. 2C shows a cross-section view of an installation nut, according to an embodiment.

FIG. 3 shows a concealed trapway, low profile toilet, according to an embodiment.

FIG. 4 shows a cut-away view of a concealed trapway, low profile toilet, according to an embodiment.

FIG. 5A and FIG. 5B show a concealed trapway, low profile toilet, according to an embodiment.

### DETAILED DESCRIPTION

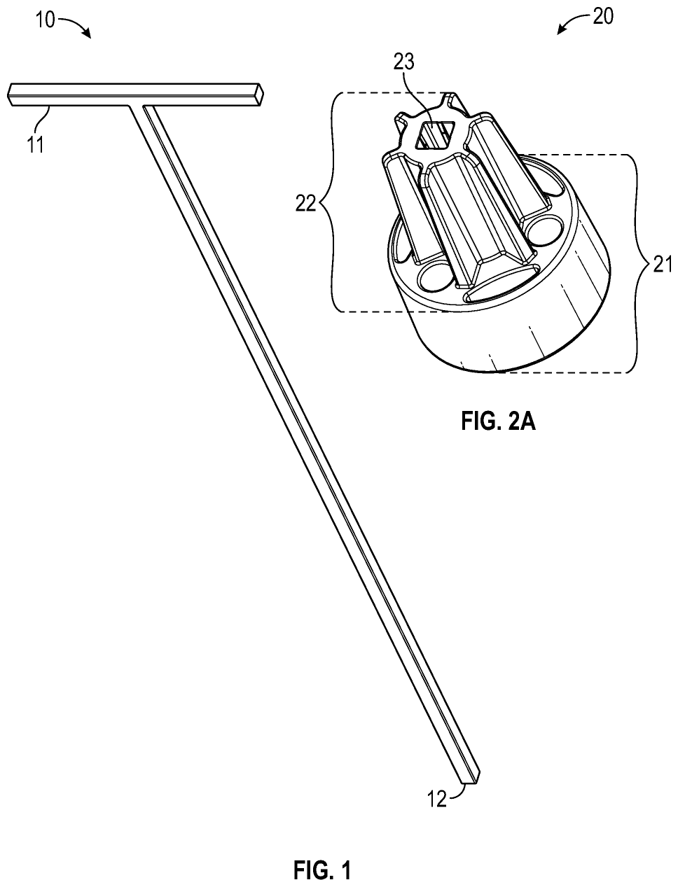

FIG. 1 shows installation wrench 10, according to an embodiment. Installation wrench 10 comprises handle 11. Installation wrench 10 is T-shaped and is a unitary construct. Wrench lower end 12 is configured to be inserted through a toilet seat post hole and to be inserted into an upper aperture of an installation nut. In this embodiment, handle 11 is about 100 mm from end to end, and wrench 10 is about 412 mm from top end to bottom end 12. Wrench 10 has a square cross-section shape, each side of the square being about 6 mm.

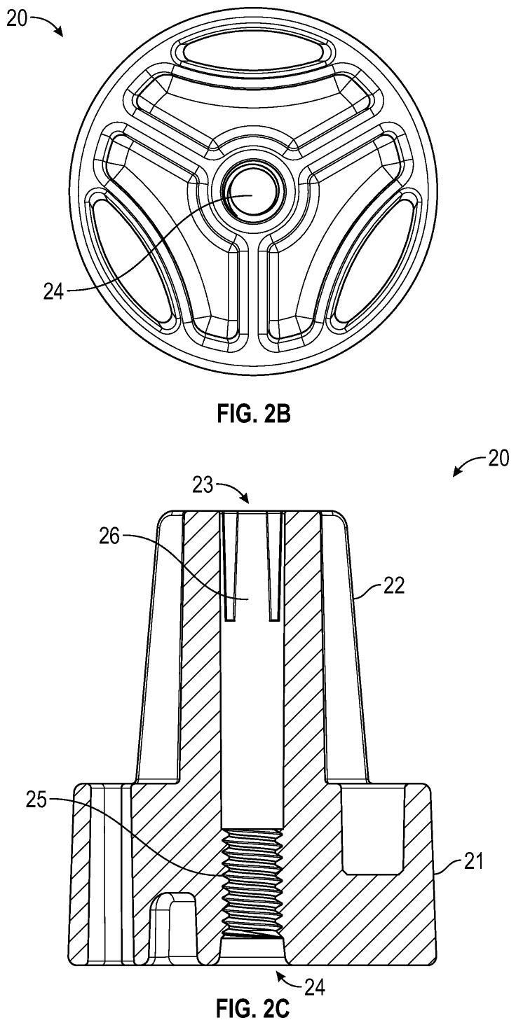

FIG. 2A and FIG. 2B show a top perspective and bottom view of installation nut 20, respectively, according to an embodiment. Nut 20 comprises a disc-shaped lower (bottom) base section 21 and an upper (top) section 22. Upper section 22 contains upper aperture 23, configured to receive and couple with installation wrench lower end 12. Nut 20 contains lower aperture 24, configured to threadingly engage and couple to a flange bolt. Wrench 10 and nut upper aperture 23 comprise corresponding square cross-section shapes. In this embodiment, nut upper aperture 23 has a largest cross-section of about 7.2 mm.

FIG. 2C shows a cross-section view of installation nut 20, according to an embodiment. Upper aperture 23 includes downwardly tapered section 26, configured so that when wrench 10 is inserted, it will grip and hold. Lower aperture 24 comprises threaded portion 25, configured to threadingly engage a flange bolt for affixing a toilet base to a floor. Upper aperture 23 and lower aperture 24 are in flow communication, allowing a bolt to extend past threaded portion 25 if necessary. In this embodiment, threaded section 25 is about 12 mm in length. Also in this embodiment, lower base section 21 is about 20 mm in height, and upper section 22 is about 30 mm in height, making the entire nut about 50 mm in height from upper aperture end to lower aperture end.

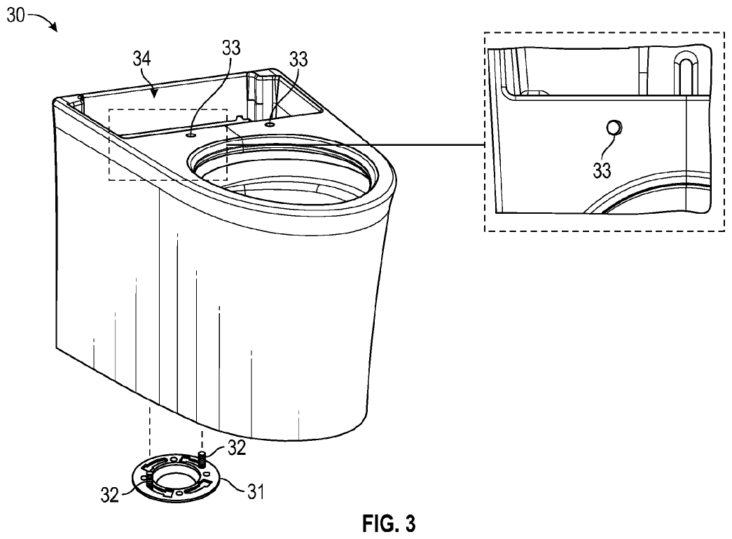

FIG. 3 shows a concealed trapway, low profile toilet 30, according to an embodiment. Toilet 30 is in a position to be lowered onto flange 31 and to receive flange bolts 32 through holes in a base of the toilet (not visible). The enlarged view shows seat post hole 33. An installation wrench may be configured to be inserted through each seat post hole 33 and to then be coupled to an installation nut. Toilet 30 comprises chamber 34, configured to receive a pressurized tank assembly. A fully assembled pressure-assist toilet to be installed will contain a pressurized tank assembly.

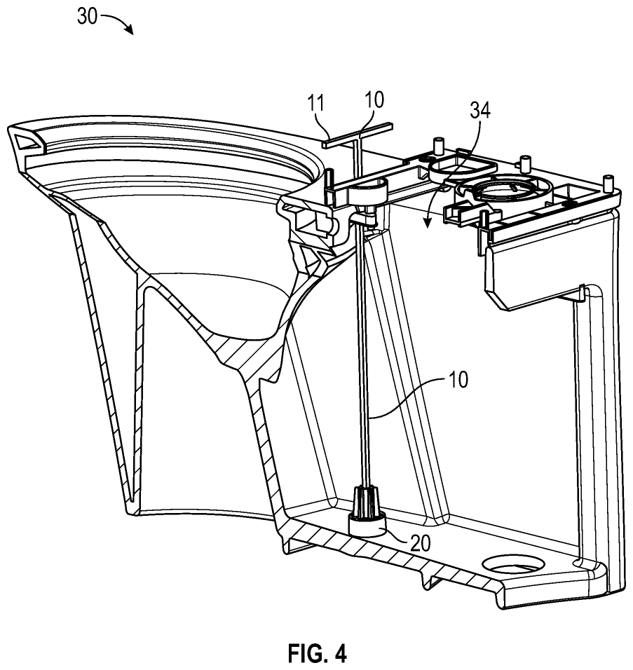

FIG. 4 provides a cross-section view of concealed trapway, low profile toilet 30, according to an embodiment. Wrench 10 is inserted through seat post hole 33 (not visible). Nut 20 is placed through chamber 34 and is coupled to wrench 10 via an upper nut aperture. Wrench 10/nut 20 installation assembly is lowered onto a flange bolt 32 (not visible). Nut 20 threadingly engages flange bolt 32 and wrench 10 is turned via handle 11 to tighten and to affix toilet 30 in place.

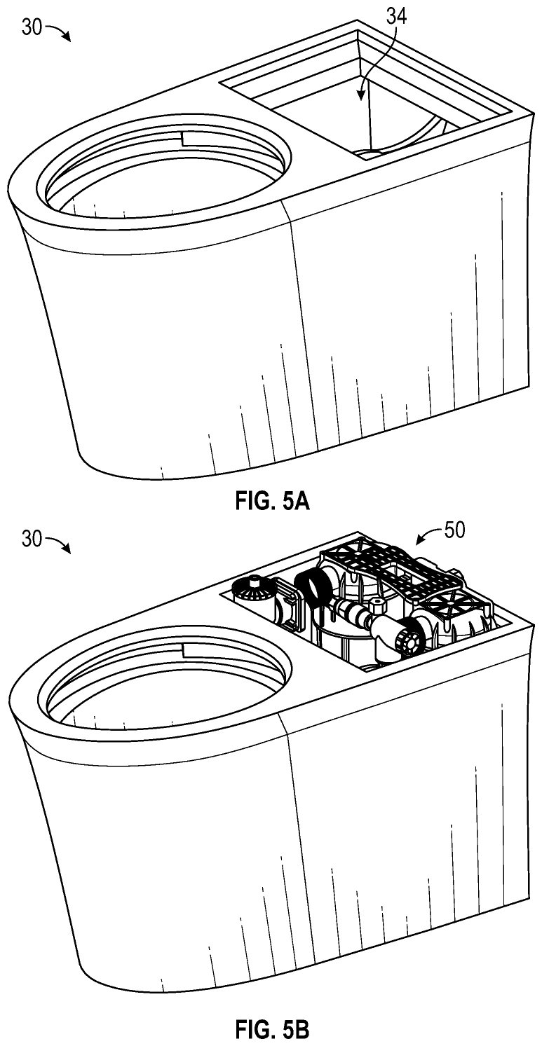

FIG. 5A shows a view of concealed trapway, low profile toilet 30, according to an embodiment. Chamber 34 is visible. FIG. 5B shows concealed trapway, low profile toilet 30, containing pressurized tank assembly 50 within chamber 34. It is seen that little space is available for attachment of a nut to a flange bolt in a fully assembled pressure-assist toilet.

In some embodiments, a wrench is configured to snugly fit into a nut upper aperture, so that the nut does not fall off the wrench upon coupling and lowering to a flange bolt. A “snug fit” may mean a wrench and nut will remain coupled unless pulled apart with a gentle force. Upon threadingly engaging a nut lower aperture with a flange bolt and tightening the nut to affix the toilet, the wrench may simply be pulled and removed from the nut. In some embodiments, a wrench and a nut upper aperture may have a corresponding shape. A wrench and/or a nut upper aperture shape (a cross-section shape) may be triangular, square, pentagonal, hexagonal, heptagonal, octagonal, and the like.

In some embodiments, a wrench and nut upper aperture may be sized so as to allow for ease of insertion of the wrench into the nut. For example, a nut upper aperture may be sized to provide a margin of from any of about 0.1 mm, about 0.2 mm, about 0.3 mm, about 0.4 mm, about 0.5 mm, about 0.6 mm, about 0.7 mm, or about 0.8 mm, to any of about 0.9 mm, about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, or greater, at any point between the wrench and the nut upper aperture.

In some embodiments, a wrench may have a largest cross-section of from any of about 4.0 mm, about 4.2 mm, about 4.4 mm, about 4.6 mm, about 4.8 mm, about 5.0 mm, about 5.2 mm, about 5.4 mm, about 5.6 mm, or about 5.8 mm, to any of about 6.0 mm, about 6.2 mm, about 6.4 mm, about 6.6 mm, about 6.8 mm, about 7.0 mm, about 7.2 mm, about 7.4 mm, about 7.6 mm, about 7.8 mm, about 8.0 mm, or more.

In some embodiments, a nut upper aperture may have a largest cross-section of from any of about 5.0 mm, about 5.2 mm, about 5.4 mm, about 5.6 mm, about 5.8 mm, about 6.0 mm, about 6.2 mm, about 6.4 mm, about 6.6 mm, or about 6.8 mm, to any of about 7.0 mm, about 7.2 mm, about 7.4 mm, about 7.6 mm, about 7.8 mm, about 8.0 mm, about 8.2 mm, about 8.4 mm, about 8.6 mm, about 8.8 mm, about 9.0 mm, or more.

In some embodiments, a nut upper aperture may comprise one or more tabs, ribs, or other features configured to grip the wrench to provide a snug fit so that the nut does not fall off the wrench upon coupling and lowering to a flange bolt. A rib may be tapered. In some embodiments, a nut upper aperture may comprise 2, 3, 4, or more evenly spaced such features around a perimeter of the upper aperture. In other embodiments, a nut upper aperture may have a decreasing perimeter along its length or a portion of its length, which will also provide for a snug fit of the wrench. In other words, a nut upper aperture or upper aperture portion may be downwardly tapered.

In some embodiments, a wrench and a nut may comprise dissimilar materials, which may aid in providing a snug fit therebetween, and which may also aid removal of the wrench from the nut. In some embodiments, a wrench may comprise a metal, for instance one or more of aluminum, copper, iron, zinc, steel, zinc plated steel, brass, or other metals. In some embodiments, a nut may comprise a thermoplastic, for instance one or more of a polyamide, a polyester, a polyolefin, a polystyrene, an acrylic, an acrylonitrile-butadiene-styrene copolymer (ABS), a polyphenylene sulfide (PPS), or one or more other polymers. In some embodiments, a nut may comprise an engineering thermoplastic, for instance one or more of an ABS polymer, a polyamide, a polycarbonate, or a PPS polymer. In some embodiments, a thermoplastic may comprise a reinforcing filler, for instance glass or talc.

In some embodiments, an installation assembly is configured so that over-tightening of the nut onto a flange bolt is prevented and therefore damage to the toilet is prevented. In some embodiments, a handle may be relatively short relative to wrench length, thus providing for lower leverage or torque. Low leverage may prevent one from over-tightening an installation nut. In some embodiments, a handle length may be from any of about 80 mm, about 83 mm, about 86 mm, about 89 mm, about 92 mm, about 95 mm, or about 98 mm, to any of about 100 mm, about 103 mm, about 106 mm, about 109 mm, about 112 mm, about 115 mm, about 118 mm, about 121 mm, about 124 mm, or more. In some embodiments, a wrench length may be from any of about 380 mm, about 385 mm, about 390 mm, about 395 mm, about 400 mm, about 405 mm, or about 410 mm, to any of about 415 mm, about 420 mm, about 425 mm, about 430 mm, about 435 mm, about 440 mm, about 445 mm, or more. For example, for a T-shaped wrench, a handle length is from one end of the T top to the other, and the wrench length is from the T top to the T bottom. In some embodiments, a ratio of handle length relative to wrench length may be from any of about 0.18, about 0.19, about 0.20, about 0.21, about 0.22, or about 0.23, to any of about 0.24, about 0.25, about 0.26, about 0.27, about 0.28, about 0.29, about 0.30, or larger. In other embodiments, a wrench may comprise an L shape. An L-shaped wrench may comprise the same dimensions as a T-shaped wrench, with part of the top T removed.

In some embodiments, the installation nut may be a unitary construct, which may be formed by molding of a thermoplastic material. The installation nut may comprise a threaded portion comprising a thermoplastic. In some embodiments, a threaded portion may be configured to slip, strip, or otherwise fail upon attempted over-tightening, thus preventing damage to the toilet. In some embodiments, an installation nut may comprise a thermoplastic and the toilet may comprise a thermoplastic, wherein the thermoplastics are different. In some embodiments, an installation nut may comprise a harder thermoplastic than the toilet. In other embodiments, the toilet may comprise a harder thermoplastic than the installation nut. A difference in hardness between the installation nut and the toilet may also prevent damage to the toilet upon attempted over-tightening of the nut.

In some embodiments, an installation nut may comprise a threaded brass insert to accept a flange bolt. In some embodiments, an installation nut may comprise a thermoplastic body and a threaded brass insert. In some embodiments, a threaded brass insert may have an outer knurled surface. As a flange bolt is threaded onto such a brass insert, a knurled surface may “bite” into a thermoplastic nut body and aid in bolt retention. In some embodiments, an outer surface of a threaded brass insert may be configured to expand upon being threaded onto a flange bolt, thus aiding coupling to a nut body.

In some embodiments, an installation wrench may comprise a square-shaped cross-section. A square-shaped cross-section may provide less torque than for instance a cross-section having more angles or surface area, such as a hexagonal shape. Thus, an installation wrench square-shaped cross-section may also help prevent over-tightening.

In some embodiments, an installation nut upper aperture and lower aperture may be connected, or in “flow communication”. Such a configuration may allow a standard flange bolt to extend beyond a lower aperture threaded portion and to be positioned in the nut. Flange bolts generally come in standard lengths, sometimes requiring cutting after installation if too long. A present installation nut may be configured to allow for standard flange bolts without cutting. The upper aperture and lower aperture are substantially concentrically aligned, meaning the passageways are aligned. In other embodiments, an installation nut upper aperture and lower aperture may not be in flow communication and may be isolated from each other.

In some embodiments, a nut may comprise a lower base section and an upper section. A lower base section comprises a lower nut aperture and an upper section comprises an upper nut aperture. In embodiments wherein an upper nut aperture and a lower nut aperture are in flow communication, a demarcation between upper and lower apertures is arbitrary. In some embodiments, a nut lower base section may be disc-shaped. In some embodiments, a nut upper section may comprise a shape configured to allow grasping by hand. In other embodiments, a nut may be substantially symmetrical with no visible difference between a base section and an upper section.

In some embodiments, a nut may have a height from the top of the upper aperture to the bottom of the lower aperture, of from any of about 40 mm, about 41 mm, about 42 mm, about 43 mm, about 44 mm, about 45 mm, about 46 mm, or about 47 mm, to any of about 48 mm, about 49 mm, about 50 mm, about 51 mm, about 52 mm, about 53 mm, about 54 mm, about 55 mm, about 56 mm, about 57 mm, about 58 mm, about 59 mm, about 60 mm, about 61 mm, about 62 mm, about 63 mm, about 64 mm, about 65 mm, or more.

In some embodiments, a nut may have a largest diameter of from any of about 30 mm, about 31 mm, about 32 mm, about 33 mm, about 34 mm, about 35 mm, or about 36 mm, to any of about 37 mm, about 38 mm, about 39 mm, about 40 mm, about 41 mm, about 42 mm, about 43 mm, about 44 mm, about 45 mm, about 46 mm, about 47 mm, about 48 mm, about 49 mm, about 50 mm, or more. A largest diameter may be at a lower base edge of a nut.

In some embodiments, a method for installing a toilet may comprise coupling an installation wrench to an installation nut by inserting a wrench lower end into a nut upper aperture to form an installation tool assembly, lowering the installation assembly so that a nut lower aperture threadingly engages a flange bolt, threadingly tightening the installation nut onto the flange bolt via turning the installation wrench, and pulling and removing the installation wrench from the installation nut. In some embodiments, an installation wrench may be inserted through a toilet seat post hole, and the installation nut may be coupled to the wrench from under the seat post hole.

In some embodiments, the toilet to be installed is a concealed trapway toilet. A concealed trapway toilet may have no side access holes and associated caps. In some embodiments, a toilet to be installed is a low profile, pressure assist toilet. A low profile, pressure assist toilet may not comprise a water tank.

Concealed trapway and/or low profile toilets are described for example in U.S. app. No. PCT/US2019/053347, filed Sep. 27, 2019 (WO2020069249), which relevant disclosures thereof are hereby incorporated by reference.

Following are certain embodiments of the disclosure.

In a first embodiment, disclosed is an installation tool assembly for a toilet, comprising an installation wrench and an installation nut, wherein the wrench is configured to be removably coupled to the nut via an upper aperture of the nut, the nut is configured to be threadingly coupled to a flange bolt via a lower aperture of the nut, and the nut upper aperture and nut lower aperture are concentrically aligned.

In a second embodiment, disclosed is an installation tool assembly according to the first embodiment, wherein the wrench is configured to be inserted through a toilet seat post hole. In a third embodiment, disclosed is an installation tool assembly according to the first or second embodiments, wherein the wrench comprises a handle. In a fourth embodiment, disclosed is an installation tool assembly according to any of the preceding embodiments, wherein the wrench is substantially T-shaped. In a fifth embodiment, disclosed is an installation tool assembly according to any of the preceding embodiments, wherein the wrench is a unitary construct.

In a sixth embodiment, disclosed is an installation tool assembly according to any of the preceding embodiments, wherein the nut is configured to be removably coupled to the flange bolt. In a seventh embodiment, disclosed is an installation tool assembly according to any of the preceding embodiments, wherein the nut comprises a lower base section and an upper section.

In an eighth embodiment, disclosed is an installation tool assembly according to any of the preceding embodiments, wherein the nut comprises a lower base section, wherein the lower base section is substantially disc-shaped. In a ninth embodiment, disclosed is an installation tool assembly according to any of the preceding embodiments, wherein the nut comprises an engineering thermoplastic polymer. In a tenth embodiment, disclosed is an installation tool assembly according to any of the preceding embodiments, wherein the nut comprises glass reinforced polyphenylene sulfide.

In an eleventh embodiment, disclosed is an installation tool assembly according to any of the preceding embodiments, wherein the nut upper aperture comprises one or more features configured to provide a snug fit of the wrench in the nut. In a twelfth embodiment, disclosed is an installation tool assembly according to any of the preceding embodiments, wherein a portion of the nut upper aperture is downwardly tapered.

In a thirteenth embodiment, disclosed is an installation tool assembly according to any of the preceding embodiments, wherein the nut upper aperture and the nut lower aperture are in flow communication. In a fourteenth embodiment, disclosed is an installation tool assembly according to any of the preceding embodiments, wherein the nut lower aperture comprises a threaded portion.

In a fifteenth embodiment, disclosed is an installation tool assembly according to any of the preceding embodiments, wherein the nut lower aperture comprises a thermoplastic threaded portion configured to prevent over-tightening.

In a sixteenth embodiment, disclosed is an installation tool assembly according to any of the preceding embodiments, wherein the wrench comprises a handle, and wherein a ratio of handle length to wrench length is from about 0.18 to about 0.30.

In a seventeenth embodiment, disclosed is an installation tool assembly according to any of the preceding embodiments, wherein the wrench and the nut comprise dissimilar materials. In an eighteenth embodiment, disclosed is an installation tool assembly according to any of the preceding embodiments, wherein the nut and the toilet comprise different thermoplastic polymers.

In a nineteenth embodiment, disclosed is an installation tool assembly according to any of the preceding embodiments, wherein the toilet is a concealed trapway toilet. In a twentieth embodiment, disclosed is an installation tool assembly according to any of the preceding embodiments, wherein the toilet is a pressure-assist toilet.

In a twenty-first embodiment, disclosed is an installation tool assembly according to any of the preceding embodiments, wherein the installation wrench comprises a square-shaped cross-section. In a twenty-second embodiment, disclosed is a wrench according to any of the preceding embodiments. In a twenty-third embodiment, disclosed is a nut according to any of the preceding embodiments.

In a twenty-fourth embodiment, disclosed is a method for installing a toilet, the method comprising inserting a wrench lower end into a nut upper aperture to form an installation tool assembly, lowering the installation tool assembly so that a nut lower aperture threadingly engages a flange bolt, turning the installation wrench to threadingly tighten the installation nut onto the flange bolt, and pulling and removing the installation wrench from the installed nut.

In a twenty-fifth embodiment, disclosed is a method according to the twenty-fourth embodiment, comprising inserting the wrench through a toilet seat post hole, and inserting the wrench lower end into the nut upper aperture from under the seat post hole.

Features described in connection with one embodiment of the disclosure may be used in conjunction with other embodiments, even if not explicitly stated above.

The term “coupled” means that an element is “attached to” or “associated with” another element. Coupled may mean directly coupled or coupled through one or more other elements. An element may be coupled to an element through two or more other elements in a sequential manner or a non-sequential manner. The term “via” in reference to “via an element” may mean “through” or “by” an element. Coupled or “associated with” may also mean elements not directly or indirectly attached, but that they “go together” in that one may function together with the other.

The term “flow communication” means for example configured for liquid or gas flow there through and may be synonymous with “fluidly coupled”. The terms “upstream” and “downstream” indicate a direction of gas or fluid flow, that is, gas or fluid will flow from upstream to downstream.

The term “towards” in reference to a of point of attachment or a location, may mean at exactly that location or point or, alternatively, may mean closer to that point or location than to another distinct point or location, for example “towards a center” means closer to a center than to an edge.

The term “like” means similar and not necessarily exactly like. For instance “ring-like” means generally shaped like a ring, but not necessarily perfectly circular.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±0.05%, ±0.1%, ±0.2%, ±0.3%, ±0.4%, ±0.5%, ±1%, ±2%, ±3%, ±4%, ±5%, ±6%, ±7%, ±8%, ±9%, ±10% or more. All numeric values are modified by the term “about” whether or not explicitly indicated. Numeric values modified by the term “about” include the specific identified value. For example “about 5.0” includes 5.0.

The term “substantially” is similar to “about” in that the defined term may vary from for example by ±0.05%, ±0.1%, ±0.2%, ±0.3%, ±0.4%, ±0.5%, ±1%, ±2%, ±3%, ±4%, ±5%, ±6%, ±7%, ±8%, ±9%, ±10% or more of the definition; for example the term “substantially perpendicular” may mean the 90° perpendicular angle may mean “about 90°”. The term “generally” may be equivalent to “substantially”.

Features described in connection with one embodiment of the disclosure may be used in conjunction with other embodiments, even if not explicitly stated.

Embodiments of the disclosure include any and all parts and/or portions of the embodiments, claims, description and figures. Embodiments of the disclosure also include any and all combinations and/or sub-combinations of embodiments.

1. An installation tool assembly for a toilet, comprising an installation wrench and an installation nut, wherein
the wrench is configured to be removably coupled to the nut via an upper aperture of the nut,
the nut is configured to be threadingly coupled to a flange bolt via a lower aperture of the nut, and
the nut upper aperture and nut lower aperture are concentrically aligned.

2. The installation tool assembly according to claim 1, wherein the wrench is configured to be inserted through a toilet seat post hole.

3. The installation tool assembly according to claim 1, wherein the wrench comprises a handle.

4. The installation tool assembly according to claim 1, wherein the wrench comprises a handle, and wherein a ratio of handle length to wrench length is from about 0.18 to about 0.30.

5. The installation tool assembly according to claim 1, wherein the wrench is a unitary construct.

6. The installation tool assembly according to claim 1, wherein the installation wrench comprises a square-shaped cross-section.

7. The installation tool assembly according to claim 1, wherein the nut is configured to be removably coupled to the flange bolt.

8. The installation tool assembly according to claim 1, wherein the nut comprises a substantially disc-shaped lower base section and an upper section.

9. The installation tool assembly according to claim 1, wherein the nut upper aperture and the nut lower aperture are in flow communication.

10. The installation tool assembly according to claim 1, wherein the nut comprises an engineering thermoplastic polymer.

11. The installation tool assembly according to claim 1, wherein the nut comprises glass reinforced polyphenylene sulfide.

12. The installation tool assembly according to claim 1, wherein the nut upper aperture comprises one or more features configured to provide a snug fit of the wrench in the nut.

13. The installation tool assembly according to claim 1, wherein a portion of the nut upper aperture is downwardly tapered.

14. The installation tool assembly according to claim 1, wherein the nut lower aperture comprises a threaded portion.

15. The installation tool assembly according to claim 1, wherein the nut lower aperture comprises a thermoplastic threaded portion configured to prevent over-tightening.

16. The installation tool assembly according to claim 1, wherein the wrench and the nut comprise dissimilar materials.

17. The installation tool assembly according to claim 1, wherein the nut and the toilet comprise different thermoplastic polymers.

18. The installation tool assembly according to claim 1, wherein the toilet is a concealed trapway toilet.

19. The installation tool assembly according to claim 1, wherein the toilet is a pressure-assist toilet.

20. A nut for installation of a toilet, wherein
the nut comprises an upper aperture and a lower aperture,
the nut upper aperture and lower aperture are concentrically aligned,
the nut lower aperture is configured to be removably threadingly coupled to a flange bolt, and
the nut upper aperture is configured to be removably coupled to a wrench.
